(19) United States
(12) Patent Application Publication
(10) Pub. No.: US 2018/0222037 A1
(43) Pub. Date: Aug. 9, 2018

(54) Adjustable Height Creeper

(71) Applicants: Joel W. Hendrickson, Bear River City, UT (US); Travis L. Hendrickson, Bear River City, UT (US)

(72) Inventors: Joel W. Hendrickson, Bear River City, UT (US); Travis L. Hendrickson, Bear River City, UT (US)

(21) Appl. No.: 15/947,784

(22) Filed: Apr. 7, 2018

Related U.S. Application Data
(60) Provisional application No. 62/506,552, filed on May 15, 2017.
(60) Provisional application No. 62/629,621, filed on Feb. 12, 2018.

(51) Int. Cl. B25H 5/00; A47C 9/02

(52) U.S. Cl. CPC B25H 5/00; A47C 9/027

(57) ABSTRACT

A creeper (AEROCREEPER™) that is used by a maintenance worker, pilot, mechanic, factory worker, etc. to give them easy access underneath and around planes, automobiles, factory equipment, etc. The AEROCREEPER™ is adjusted to various heights by the operator to support the operator's body in the optimal position for the task. The AEROCREEPER™ can be easily and quickly adjusted to the desired position. The AEROCREEPER™ is made up of four main assemblies: base assembly, backrest assembly, support arm assembly and seat assembly.

### CROSS REFERENCE TO RELATED APPLICATIONS

This US nonprovisional utility patent application claims the benefit under 35 USC § 119(e) of U.S. provisional application No. 62/506,552 filed May 15, 2017 and No. 62/629,621 filed Feb. 12, 2018, both of which are expressly incorporated herein in their entirety by this reference.

### FIELD OF THE INVENTION

The present invention relates to wheeled work platforms such as for use in providing improved access to the underbody of a vehicle and generally referred to as creepers.

### BACKGROUND OF THE INVENTION

Creeper devices are widely used in repair shops and factories to allow an operator to lay in a low position to work underneath or around automobiles or other equipment. Many times operators are required to be at different heights to work around automobiles, airplanes or other equipment. There are several creepers that convert between two positions. These creepers can be helpful, but they lack the flexibility of multiple positions. Such creepers are shown in the following US patents and applications and are expressly incorporated herein by reference: RE35,732, 5,707,067, 6,199,877, 6,425,590, 6,834,868, 6,969,077, and 2012/023537.

The creeper shown in U.S. Pat. No. 9,193,064 offers multiple positions using a hydraulic system and multiple linkages, and is expressly incorporated herein by reference. Even though this creeper can be quite useful for working in various elevated positions, the complexity of this creeper increases the cost as well as has the potential for more repair and maintenance issues. Other disadvantages of a hydraulic system is that adjusting the height is relatively slow and raising the seat requires repeated hand pumping motions.

An object of the present invention is to provide working positions from supine to a chair position without hydraulics. The creeper in the present invention can transform between a flat configuration to a chair configuration with several intermediate positions. Multiple positions allow the operator to choose the most comfortable or convenient position for the work being performed.

Another object of the present invention is to provide quick and easy adjustment of the seat and backrest. The seat and backrest in the present invention are raised simply by lifting the backrest to the desired height and it automatically locks into place. To lower the seat and backrest, the operator simply lifts on the front of the seat and lets it lower to the desired position.

A third object of the present invention is to provide the previously described objects at a low price compared to complex hydraulic systems.

### SUMMARY OF THE INVENTION

The primary purpose of this adjustable-height creeper is for working on or around airplanes. This creeper can be adjusted to the optimal height for various jobs.

The creeper includes a base assembly which is attached to four wheels. The backrest assembly is attached to the base assembly and supports the seat assembly. The seat assembly is also supported by support arm assembly which locks into one of the many positions on the seat assembly depending on the desired height. The support arm assembly includes rollers which roll along the base assembly as the seat and backrest are moved to different positions. The creeper positions are easily adjusted by either lifting on the backrest or lifting on the seat assembly.

To raise the seat and backrest one simply lifts up on the backrest. This causes the support arm assembly, which is pivotally connected to the backrest assembly, to pivot to a more vertical position. When the backrest is released, the support arm assembly automatically locks into position, supporting the seat in the desired position. As the backrest is raised the seat raises with it. This is to add simplicity and comfort to the creeper.

To lower the seat and backrest one simply lifts up on the front of the seat. This disengages the lock, and the seat is lowered by gravity. When the desired position is met, the seat is returned to its horizontal position and the support arm assembly, which was rotating to a more horizontal position, locks into place. For an easier and more controlled lowering of the seat and backrest a spring or dampening device, can be used.

Rollers at the end of the support arms are positioned both above and below the base frame. When raising the seat and backrest, the bottom rollers come into contact with the base frame and keep the support arms connected to the base assembly. When lowering the seat, the top rollers roll freely along the base frame allowing easy adjustment. The top rollers support the load of the creeper and the operator. The rollers are made of a material with sufficient strength to support the load of the creeper and the operator while maintaining low friction. Guide plates keep the rollers aligned with the base frame and ensure that the support arms will always be connected to the base frame.

The creeper assembly was designed to avoid hazardous pinch points. Spacing between moving members is sufficiently wide that a finger would fit in the gaps instead of pinching or shearing the finger.

The creeper assembly is also designed to fold into itself, so that the seat and backrest sit inside the base frame, allowing a low bottom position.

### DESCRIPTION OF DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a rear isometric view of a first embodiment of the invention with the apparatus in an upright chair position;

FIG. 2 is a front isometric view of a first embodiment of the invention with the apparatus in a supine position;

FIG. 3 is a front isometric view of a first embodiment of the invention with the apparatus in a lower intermediate position;

FIG. 4 is a front isometric view of a first embodiment of the invention with the apparatus in an upper intermediate position;

FIG. 5 is a front isometric view of a first embodiment of the invention with the apparatus in an upright chair position;

FIG. 6 is a side view of a first embodiment of the invention with the apparatus in a supine position.

FIG. 7 is a side view of a first embodiment of the invention with the apparatus in a lower intermediate position.

FIG. 8 is a side view of a first embodiment of the invention with the apparatus in an upper intermediate position.

FIG. 9 is a side view of a first embodiment of the invention with the apparatus in an upright chair position;

FIG. 10 is a bottom isometric view of a seat assembly of a first embodiment of the invention, and;

FIG. 11 is a front isometric view of a second embodiment of the invention with the apparatus in an upper intermediate position.

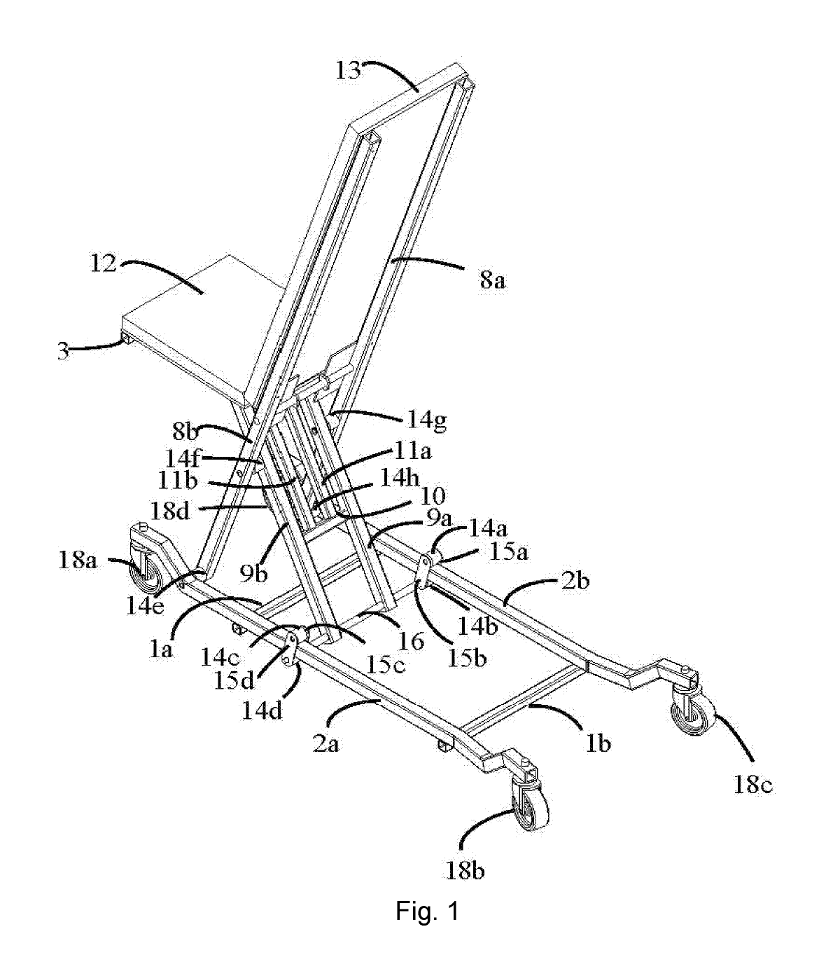

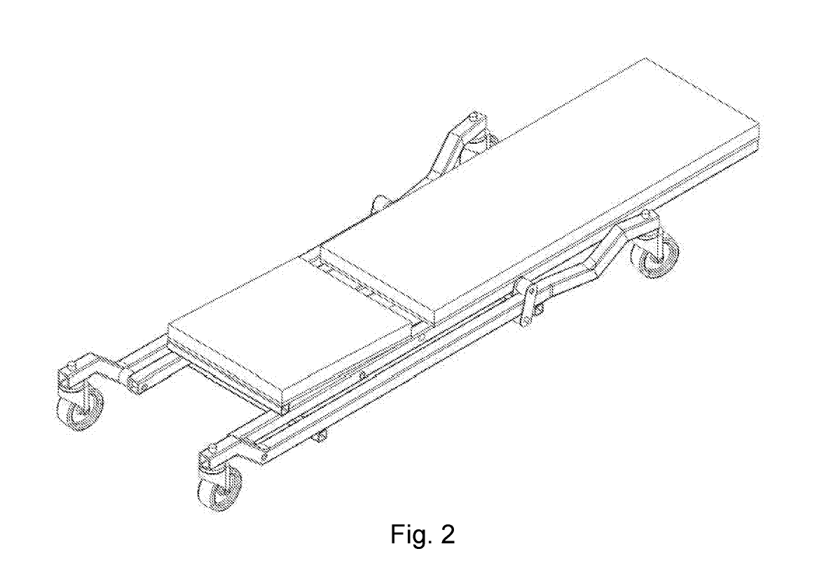

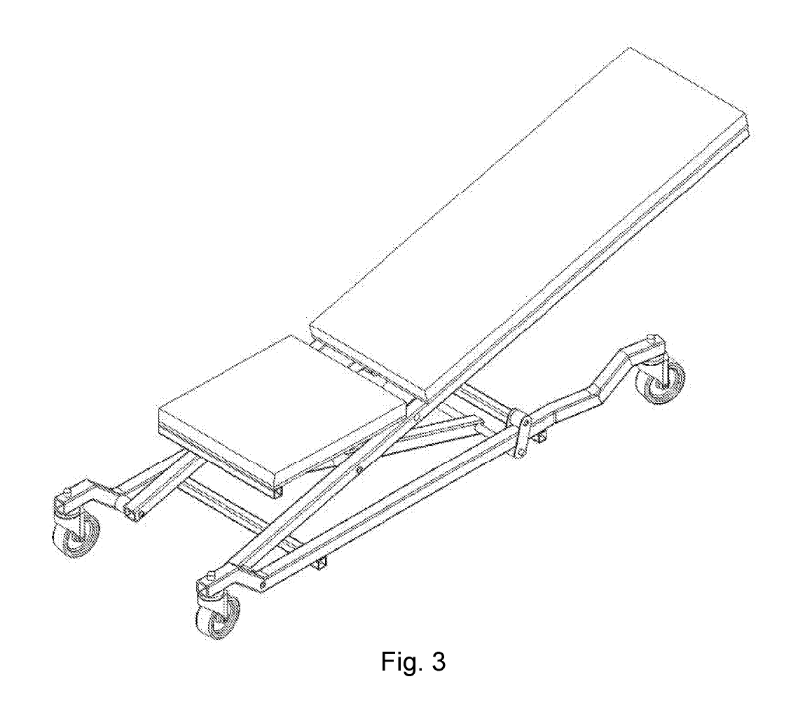

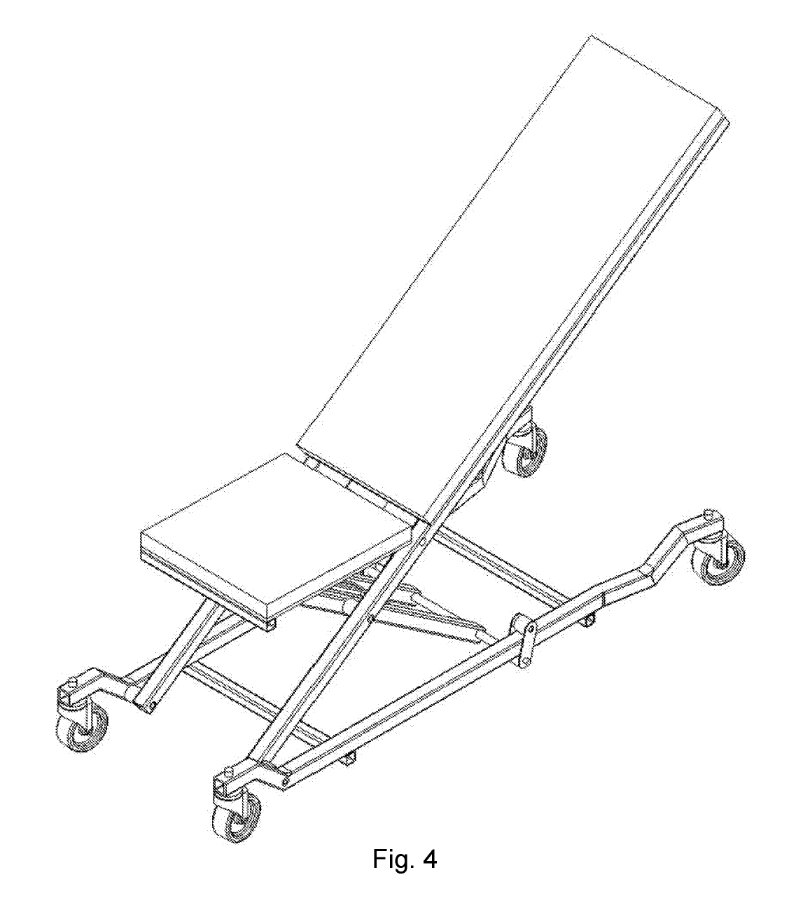

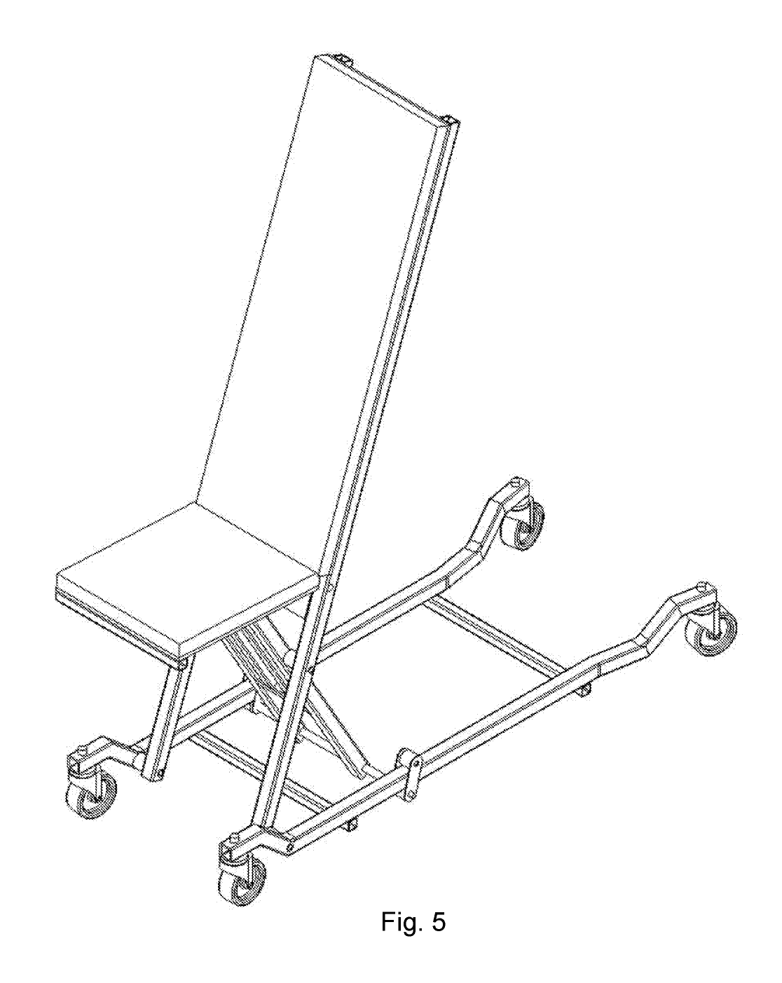

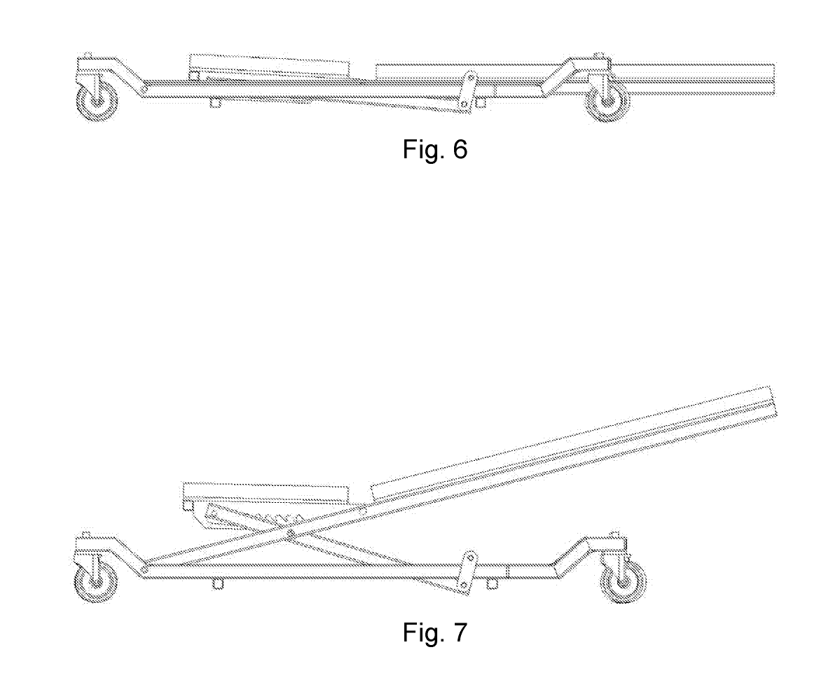

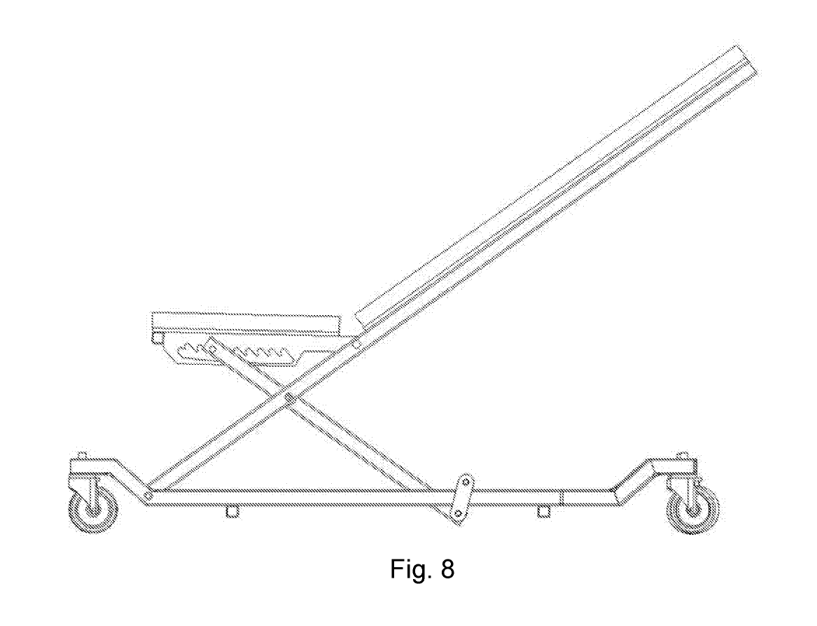

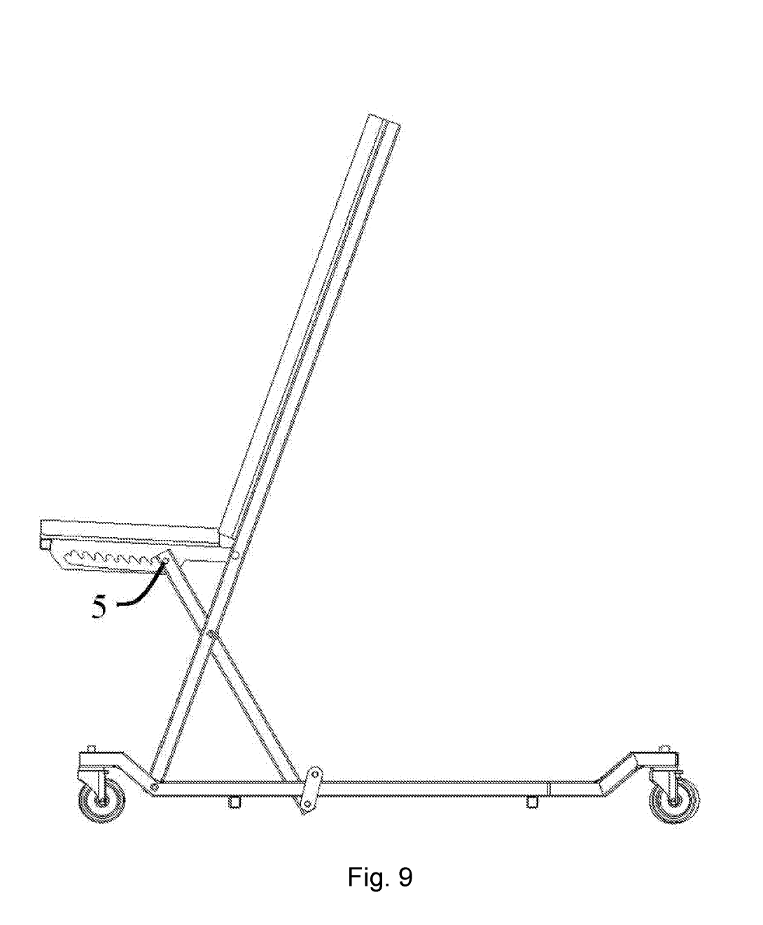

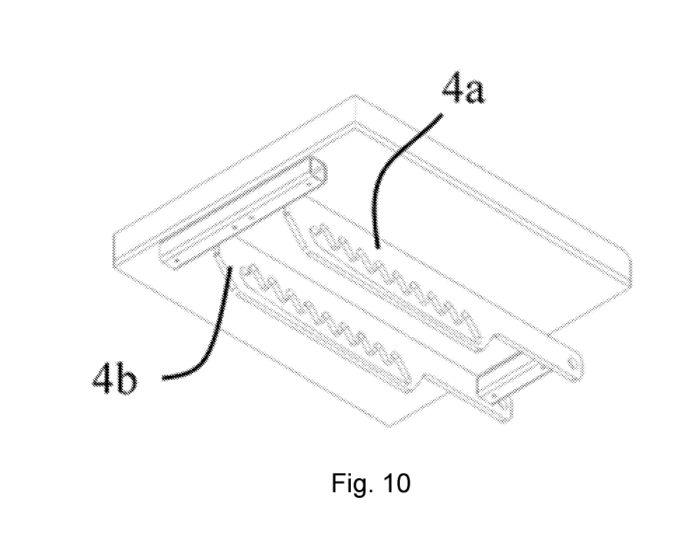

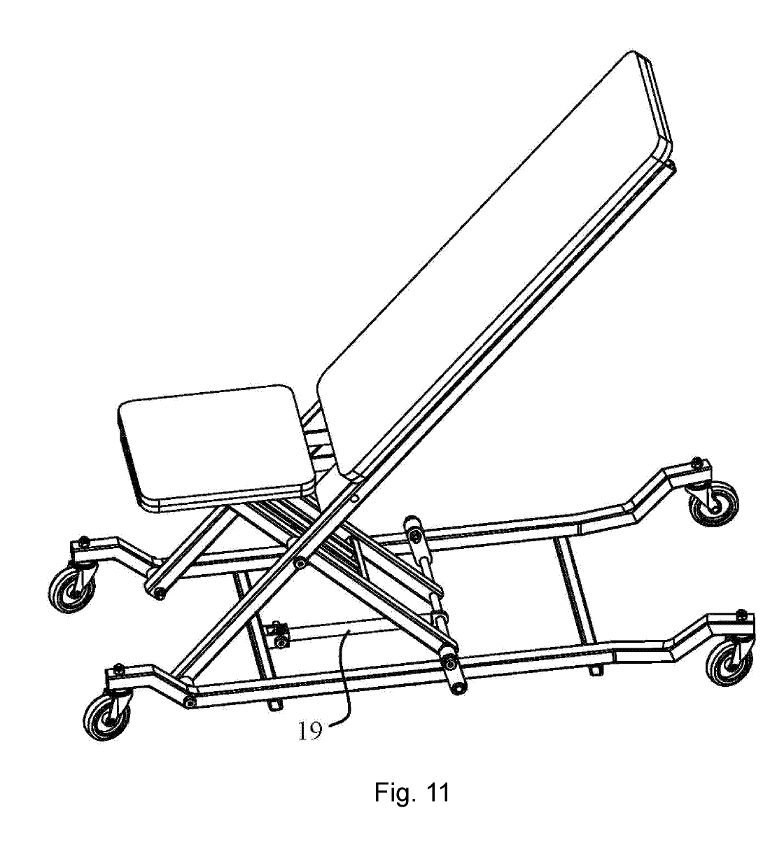

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are included to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

In order to facilitate the understanding of the present invention in reviewing the drawings accompanying the specification, a feature list is provided below. It is noted that like features are like numbered throughout all of the figures.

FEATURE TABLE

| # | Feature | # | Feature |
|---|---|---|---|
| 1a | First cross member | 1b | Second cross member |
| 2a | First side | 2b | Second side |
| 3 | Seat front cross piece | 4a | First indexing teeth |
| 4b | Second indexing teeth | 5 | Indexing rod |
| 8a | First frame side | 8b | Second frame side |
| 9a | First main support arm | 9b | Second main support arm |
| 10 | Support arm cross piece | 11a | First small support arm |
| 11b | Second small support arm | 12 | Seat |
| 13 | Backrest | 14a | First roller |
| 14b | Second roller | 14c | Third roller |
| 14d | Fourth roller | 14e | First spacer |
| 14f | Second spacer | 14g | Third spacer |
| 14h | Fourth spacer | 15a | First guide plate |
| 15b | Second guide plate | 15c | Third guide plate |
| 15d | Fourth guide plate | 16 | Roller rod |
| 18a | First swivel caster | 18b | Second swivel caster |
| 18c | Third swivel caster | 18d | Fourth swivel caster |
| 19 | Spring/damper | | |

Referring now to the drawings, a first embodiment of the invention is a creeper apparatus having, a base assembly, a backrest assembly, a support arm assembly and a seat assembly.

The base assembly is made up of the base frame and swivel casters.

The base frame consists of two sides 2a and 2b that support the weight of the creeper and operator and two cross members 1a and 1b that connect the sides to form a rectangular base frame. The cross members also support the seat and backrest in the lowest position.

The base frame is attached to four swivel casters 18a, 18b, 18c, and 18d. These casters are used to support the weight of the creeper and the operator. The casters are also used so that the operator can easily maneuver the creeper to the desired location.

The base sides 2a and 2b are bent to provide sufficient clearance for the casters while providing a low folded position. The base sides also provide a track for rollers 14a, 14b, 14c, and 14d as the seat position is adjusted.

The backrest assembly is made up of a frame consisting of two sides 8a and 8b and a backrest 13. The backrest frame is connected pivotally to the base frame with spacers 14e though 14h that provide clearance to avoid hazardous pinch points. The backrest is upholstered with padding and a supporting plate or board and is connected to the backrest frame.

The support arm assembly consists of the main support arms 9a and 9b, two small support arms 11a and 11b, and a support arm cross piece 10.

The support arm assembly is pivotally connected to the backrest assembly. It is attached to the base frame with rollers 14a, 14b, 14c, and 14d on top and bottom of the base sides 2a and 2b. The support arm assembly supports the seat assembly with the indexing rod 5 engaged in the indexing teeth 4a and 4b. The indexing rod 5 is supported by the two small support arms 11a and 11b and by the main support arms 9a and 9b. The two small support arms are supported by the support arm cross piece 10. The two small support arms function to decrease the bending moment on the indexing rod 5. The other end of the support arm assembly is attached to the roller rod 16. This rod is attached to the rollers 14a, 14b, 14c, and 14d and the guide plates 15a, 15b, 15c, and 15d. The rollers roll along the base assembly as the seat and backrest are raised and lowered. The guide plates are to support the downward load as well as to prevent movement from side to side.

The seat assembly is made up of a seat 12, indexing teeth 4a and 4b and the front seat cross piece 3.

The seat 12 is upholstered with padding and a supporting plate or board. This seat is attached to the front seat cross piece 3. The cross piece is attached to the front of the indexing teeth 4a and 4b. The back of the indexing teeth are pivotally connected to and supported by the backrest assembly. The front of the indexing teeth is supported by the indexing rod 5. The indexing teeth are designed to slide across the indexing rod as the seat and backrest are raised. The indexing rod locks into the indexing teeth as soon as the backrest is released. To free the indexing rod in order to lower the seat and backrest, one simply lifts up on the front of the seat and lowers to the desired position. Once the desired position is reached one simply releases the seat allowing the indexing rod and indexing teeth to engage. (Note: for controlled lowering, it is best to hold the backrest with the other hand.)

A second embodiment of the invention is the same as the first embodiment but with the addition of a spring or damper or a combined spring/damper 19 that would better control the descent of the creeper.

A third embodiment of the invention is the same as the first embodiment but uses a continuously adjustable mechanical device for raising and lowering instead of the use of indexing teeth. An example of such a mechanism would be a worm-gear winch and cable system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An adjustable-height creeper for use in working underneath and around airplanes, automobiles, and like equipment comprising a base frame, a plurality of wheels, a backrest, and a seat, wherein said creeper is adjustable without hydraulic assistance such that said creeper is repositionable from a supine configuration to a chair configuration and from a chair configuration to a supine configuration.

2. The creeper of claim 1, wherein said repositionability of said creeper defines at least one of a repositionability having a plurality of discrete predetermined configurations between a supine configuration and a chair configuration, and a repositionability that is substantially infinitely repositionable between a supine configuration and a chair configuration.

3. The creeper of claim 1, wherein the elevation of said seat and the elevation and inclination of said backrest are adjustable.

4. The creeper of claim 1, wherein said creeper includes at least one index member adapted to support said discrete predetermined configurations.

5. The creeper of claim 1, wherein said backrest includes a frame and wherein said seat is pivotably connected to said backrest frame, and wherein said backrest is pivotably connected to said base frame.

6. The creeper of claim 1, wherein said repositionability of said creeper defines a single motion repositionability wherein repositioning movement of said seat and said backrest is synchronous.

7. The creeper of claim 2, wherein repositioning to a discrete predetermined configuration occurs in response to a pulling load applied to a predetermined location on said creeper.

8. The creeper of claim 7, wherein when said repositioning is a downward repositioning, said repositioning is gravity assisted.

9. The creeper of claim 1, wherein said creeper includes a plurality of seat rollers and backrest rollers, and wherein said base frame includes a roller guide track formed therein.

10. The creeper of claim 9, wherein said creeper is configured to include rollers encasing said guide track and adapted such that said rollers are prevented from leaving said track when said creeper is repositioned.

11. The creeper of claim 9, wherein said creeper includes support arms attached to said rollers and positioned below said base frame to provide for a substantially low supine configuration.

12. The creeper of claim 1, wherein said seat remains substantially horizontal regardless of the configuration in which said creeper is positioned.

13. The creeper of claim 1, wherein said creeper is substantially free of pinch points.

14. The creeper of claim 1, wherein said creeper includes a dampening device adapted to provide modulated repositioning descent.

15. An adjustable-height creeper for use in working underneath and around airplanes, automobiles, and like equipment comprising a base frame, a plurality of wheels, a backrest, and a seat, wherein said creeper is adjustable without hydraulic assistance such that said creeper is repositionable from a supine configuration to a chair configuration and from a chair configuration to a supine configuration, and wherein said repositionability of said creeper defines a single motion repositionability wherein repositioning movement of said seat and said backrest is synchronous, and wherein said seat remains substantially horizontal regardless of the configuration in which said creeper is positioned.

16. The creeper of claim 15, wherein said repositionability of said creeper defines at least one of a repositionability having a plurality of discrete predetermined configurations between a supine configuration and a chair configuration, and a repositionability that is substantially infinitely repositionable between a supine configuration and a chair configuration.

17. The creeper of claim 15, wherein said creeper is substantially free of pinch points.

18. The creeper of claim 15, wherein said creeper includes a dampening device adapted to provide modulated repositioning descent.

19. An adjustable-height creeper for use in working underneath and around airplanes, automobiles, and like equipment comprising a base frame, a plurality of wheels, a backrest, and a seat, wherein said creeper is adjustable without hydraulic assistance such that said creeper is repositionable from a supine configuration to a chair configuration and from a chair configuration to a supine configuration, and wherein the elevation of said seat and the elevation and inclination of said backrest are adjustable, and wherein said backrest includes a frame and wherein said seat is pivotably connected to said backrest frame, and wherein said backrest is pivotably connected to said base frame, and wherein said repositionability of said creeper defines a single motion repositionability wherein repositioning movement of said seat and said backrest is synchronous, and wherein said seat remains substantially horizontal regardless of the configuration in which said creeper is positioned, and wherein said creeper is substantially free of pinch points.

20. The creeper of claim 19, wherein said creeper includes a dampening device adapted to provide a modulated repositioning descent.
